(19) United States
(12) Patent Application Publication
(10) Pub. No.: US 2017/0119507 A1
(43) Pub. Date: May 4, 2017

(54) ARRANGEMENT AND METHOD FOR MANUFACTURING CUSTOM OBJECTS SUCH AS DENTAL RESTORATIONS

(71) Applicants: Mikael ESCOBAR, Viry Chatillon (FR); Benoit BOCQUILLON, Saint-Orens des Gameville (FR); Fédéric COURTEILLE, Villefranche de Lauragais (FR)

(72) Inventors: Mikael ESCOBAR, Viry Chatillon (FR); Benoit BOCQUILLON, Saint-Orens des Gameville (FR); Fédéric COURTEILLE, Villefranche de Lauragais (FR)

(21) Appl. No.: 15/313,023

(22) PCT Filed: May 18, 2015
(86) PCT No.: PCT/IB2015/000840

§ 371 Date: Nov. 21, 2016

(30) Foreign Application Priority Data
May 22, 2014 (SE) 1400260-4

(51) Int. Cl. A61C 13/00; A61C 5/77; A61C 13/34; A61C 9/00; A61C 1/08

(52) U.S. Cl. CPC A61C 13/0004; A61C 9/0053; A61C 1/088; A61C 13/34; A61C 5/77

(57) ABSTRACT

The invention relates to an arrangement and a method for manufacturing custom objects, for instance dental restorations such as dental prostheses, bridges, crowns, caps, inlays, onlays, implants, abutments or other dental products. The arrangement comprises a device for scanning a model of a dental restoration or other custom object, control means (2) for the scanning device, online server (3) and manufacturing facilities (4). The scanning is performed by means of a self contained computer-automated photo unit (1) for taking a series of photographs for capturing the three-dimensional surface of the custom object to provide a passive 3D reconstruction of the object. Each photo unit (1) has a private wifi network (5) and is controlled by any kind of connected device such as mobile phone, tablet, personal computer, connected watches, interne browser or similar control means (2). Each unit (1) is connected to an online server (3) for updating, maintaining, and managing each unit, and arranged to send all the information for manufacturing the dental restoration or other custom object (Id, 3D file, parameters, etc.) to the online server (3) when a manufacturing order is done.

The present invention relates to an arrangement and a method for manufacturing custom objects such as dental restorations. The dental restorations might be dental prostheses, bridges, crowns, caps, inlays, onlays, implants, abutments or other dental products. The arrangement generally comprises a device for scanning a model of a dental restoration or other custom object, control means for the scanning device, online server and manufacturing facilities.

Systems for manufacturing individually and accurately designed dental products are commercially available on the market. Reference is made for instance to the PROCERA CAD/CAM system, but there are also several others on the market today.

CAD/CAM dentistry has been used since the 1980's in dental laboratories and the use has also been increased within dental practises. An in-house CAD/CAM system enables the dentist to create a finished dental product in as little as a couple of hours instead of using a remote dental laboratory

A typical CAD/CAM system includes scanning of the custom object in the form of a denture model or the like by means of a digital 3D scanner. An image (scan) is taken of the object and the image, the digital impression, is drawn into a computer. Together with any additional restorative design made by the dentist this virtual data is then sent to a milling machine for making the dental product.

In US 2007/0243503 it is described a system for making a dental restoration comprising a 3D optical scanner, a computer connected to the optical scanner and capable of creating a 3D graphic representation of a model of the dental restoration. The computer is used to convert the 3D graphic representation of the model into a milling path for milling the dental restoration in a block of a suitable dental restoration material. A mill present in the dentists office mills the dental restoration from the block using the milling path while the patient is waiting. The dentist can then take the milled dental restoration and apply it to the patient in the same, single visit.

Scanning of the object is an inevitable part of such a system and there are several scanners for the dental industry on the market today. The scanner used in said US 2007/0243503 is a laser type scanner in which a laser capable of emitting a flat beam is used as a photo-emitter. A CMOS captor or a CCD camera is used as a photo-receptor to detect rays of the laser beam reflected from the model as the model is rotated about a rotation axis on 360 degrees by rotating the model holder. The laser is power modulated and provides structured light to the captor.

In US 2009/0284755 it is described another type of 3D optical scanner which also can be used in the dental industry, specifically for work in orthodontics. The scanner comprises an object carrier for fixing the measurement object and an areally operating 3D sensor based on white-light projection of fringes. Measurement is based on a process that involves illuminating the surface of the measured object with a fringe pattern. A camera observes the illuminated object from the side. The surface shape of the object is calculated according to the resulting displacement of the fringes.

The mechanical system of the scanner performs automatically measurements under different viewing angles of the object relative to the 3D sensor. The measurements are merged by the scanner software to provide a 3D image of the model. The results are available in STL file format and can be used for computerized design and production of dental prostheses in a CAD/CAM production system.

In US 2012/0221135 it is described an online system for manufacturing a dental mold comprising a 3D scanner to provide graphic data of a damaged tooth. The 3D scanner is a part of the system but the type of 3D scanner is not specifically described.

In US 2010/0239136 it is described a scanner used for scanning an object, in particular one or more teeth or a dental cast. The scanner comprises a carrier on which a plurality of projectors for projecting a pattern onto the object and a plurality of cameras for recording the object are provided one beside the other in an array.

In KR 20040001698 it is described a system and a method for offering a digital teeth model using the internet and a 3D scanner arrangement including two different scanners (22, 26).

In KR 20090078539 it is described a three dimensional measure system for dental prostheses comprising an image-acquisition unit equipped with a camera acquiring a laser image irradiated on the measurement object.

In KR 20120065307 it is described a 3D scanner for a dental desktop to scan objects of various shapes including a camera and a projector. The camera is arranged to rotate around a horizontal rotary shaft and the projector has a rotary flow part.

Even if systems of the type which have been described here have increased the speed of design and creation, convenience and simplicity of the dentists work, these system still suffer from drawbacks. As accuracy of dental restorations is basic—crowns and bridges require an extremely precise fit—the scanning and milling accuracy has been critical. For that reason more or less sophisticated and complex scanners have been used, based on laser technology, structured light, fringe patterns and conoscopic holography or the like, which is indicated by the above prior art examples. So even if the experience of present CAD/CAM systems are indeed very positive there is a need to further simplify and reduce the costs for the systems, specifically with respect to the scanning process.

An object of the present invention is therefore to provide a more simple and convenient manufacturing system for dental restorations and other custom objects but which still has a high degree of accuracy so that the restorations can be designed and precisely manufactured.

A further object of the invention is to provide a system which can be controlled by a dentist or other operator by any kind of connected devices, such as mobile phones, tablets, personal computers, connected watches, interne browser etc, using local wifi and Internet.

The above mentioned objects are achieved by using al photographic technique for taking photographs of the desired object by means of a so-called photo studio apparatus. In U.S. Pat. No. 6,106,124 it is described a self contained photography studio apparatus for photographing one or more subjects. The apparatus comprises a housing with a light box and support for the subject to be photographed. The apparatus also comprises means for illuminating the subject so as to provide uniform illumination and substantially eliminate shadows, means for controlling temperature etc, and wherein each of these means is integral.

Computer-automated photo studios of this type are commercially available on the market for possible use in jewelery, watches, glasses, bottles, cosmetics, shoes, electronics, small hardware, telephony or the like, see for instance “The ScanCube Solution” at www.scancube.fr. In this case the photo studios have been used from photo shooting to the creation of animated visuals.

The present invention is based on such a computer-automated photo studio but has been specifically developed and designed for use in a manufacturing system, specifically for dental restorations but also for other custom objects.

According to the invention the scanning is performed by means of a self contained computer-automated photo unit for taking a series of photographs for capturing the three-dimensional surface of the object to provide a passive 3D reconstruction of the object, each unit having a private wife network and controlled by any kind of connected device such as mobile phone, tablet, personal computer, connected watches, internet browser or the like, wherein each unit is connected to an online server for update/maintain/manage each unit and wherein each unit is arranged to send all the information for manufacturing the dental restoration or other custom object (Id, 3D file, parameters etc) to the online server when an order is done.

According to a preferred embodiment of the invention each unit is connected to the online server through internet, and said online server is arranged to update, maintain and manage each unit through a virtual private network , for instance a vpn network, record all the data and transmit the data to the manufacturing facilities.

According to a further preferred embodiment the photo unit comprises a box-like housing with a support for the object to be photographed, a computer-controlled built-in digital camera and a lighting system for illuminating the object to scan so as to provide uniform illumination and substantially eliminate shadows

An example of the invention will now be described in more detail with reference to the enclosed drawings, in which:

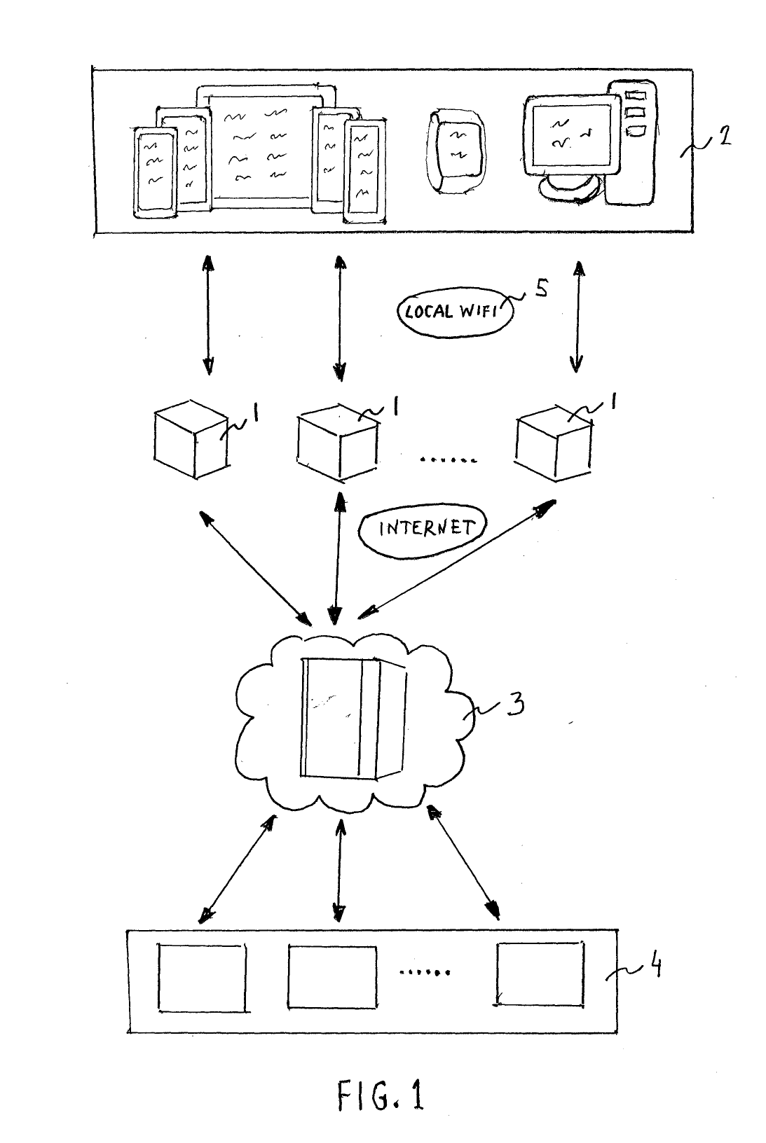

FIG. 1 is a block circuit diagram of an overall system for making dental restorations according to the invention,

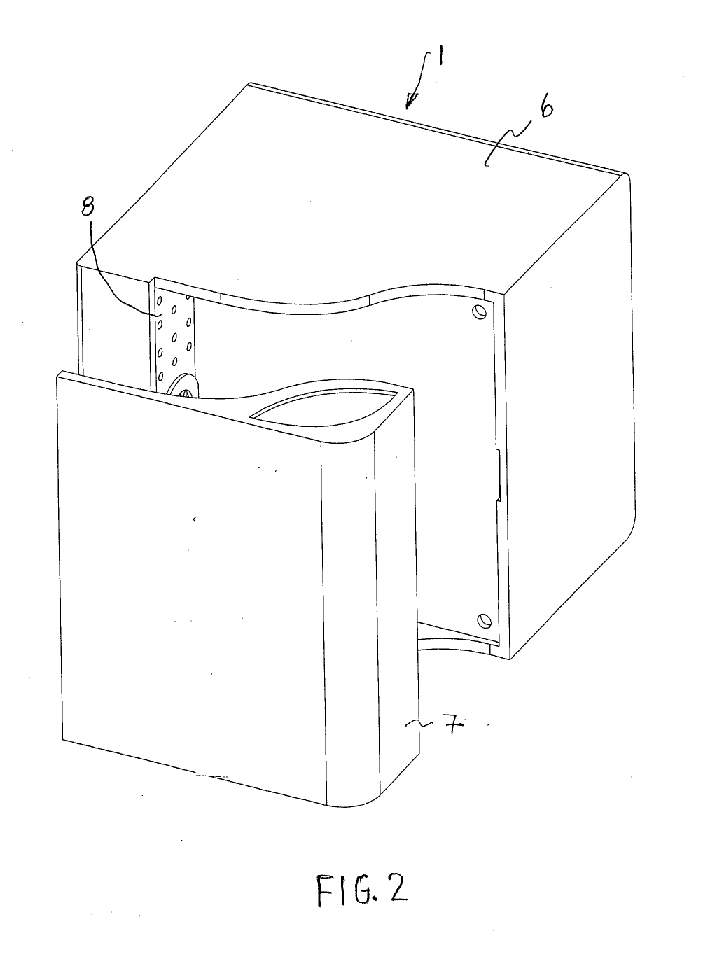

FIG. 2 is a schematic perspective view of a specific photo unit to be used in the system,

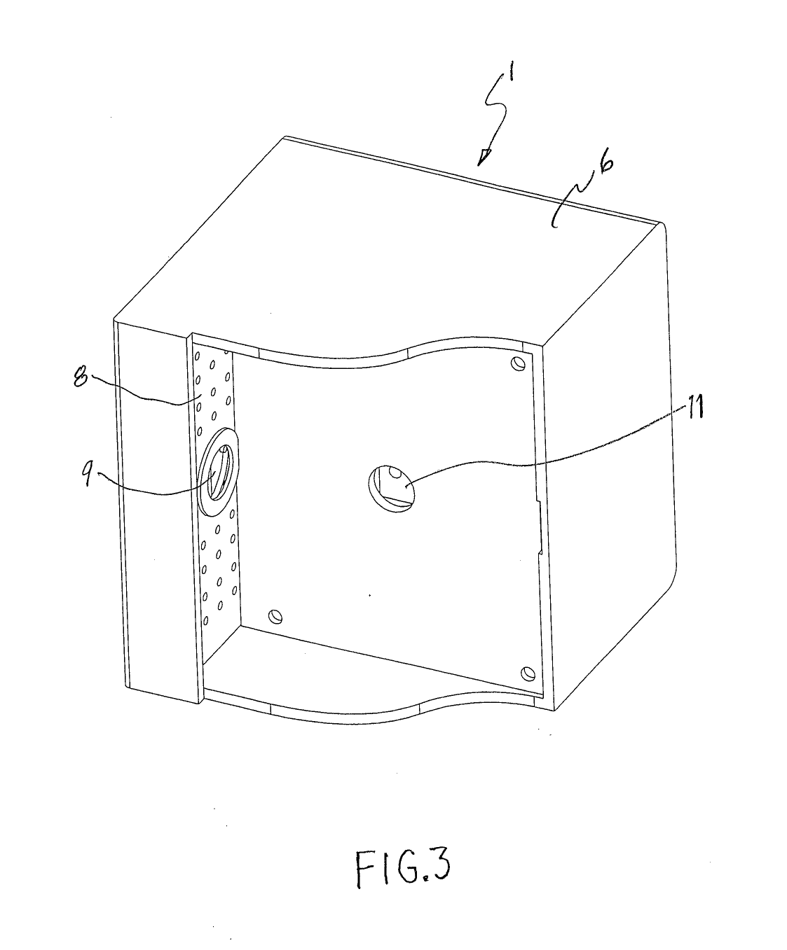

FIG. 3 is a schematic perspective view partly showing the internal of the photo unit,

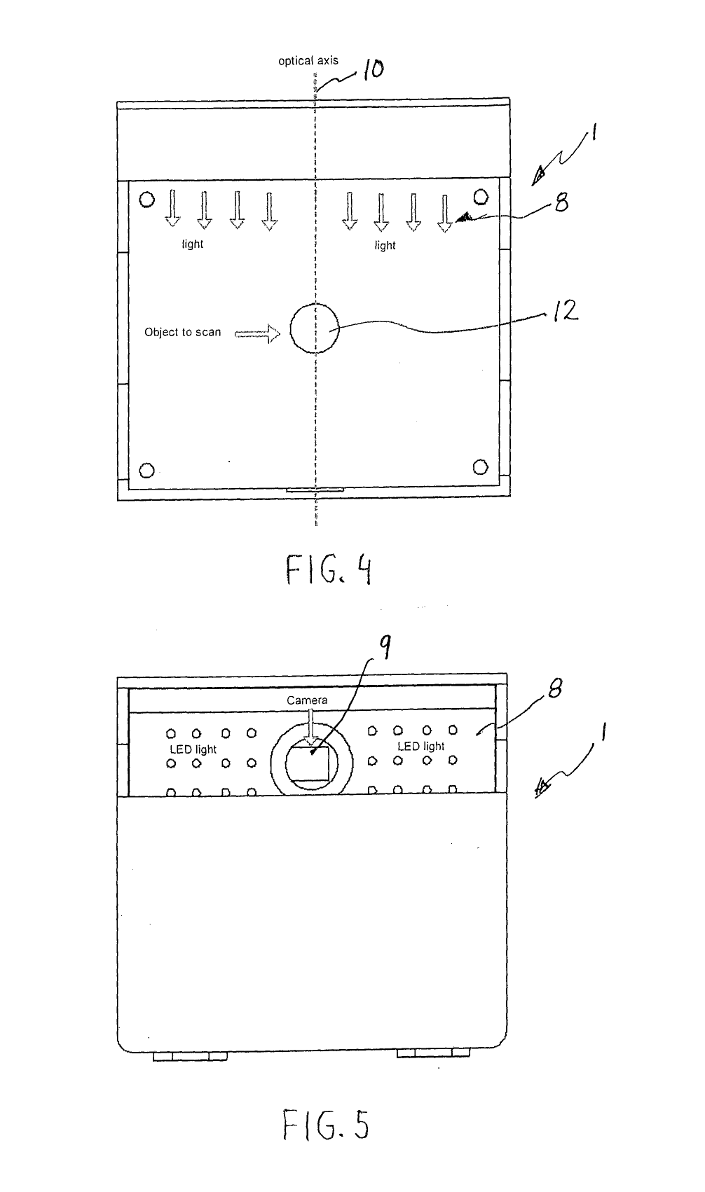

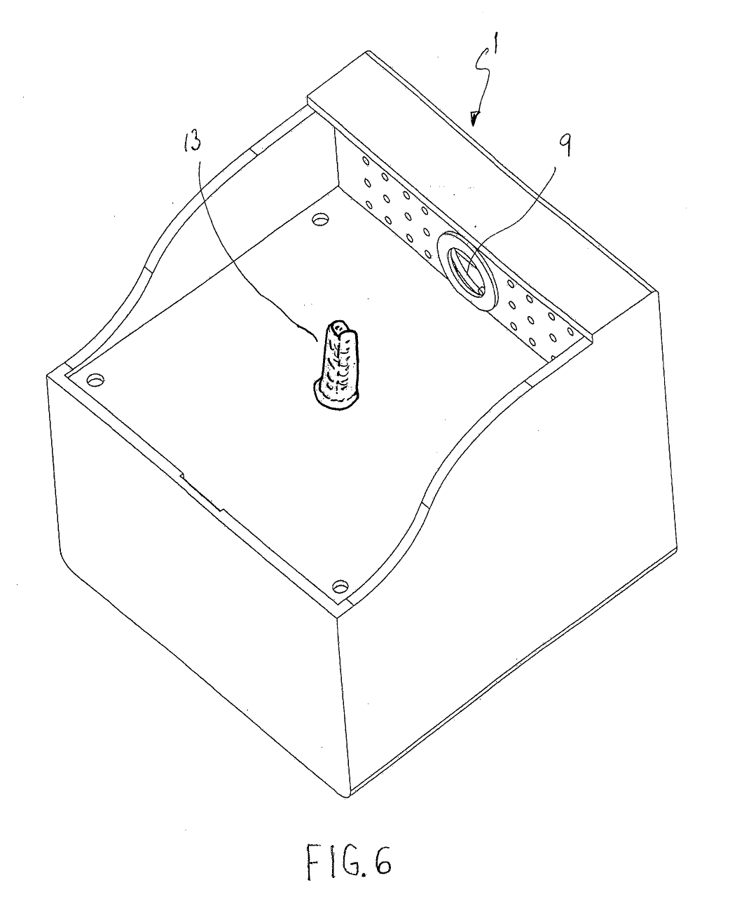

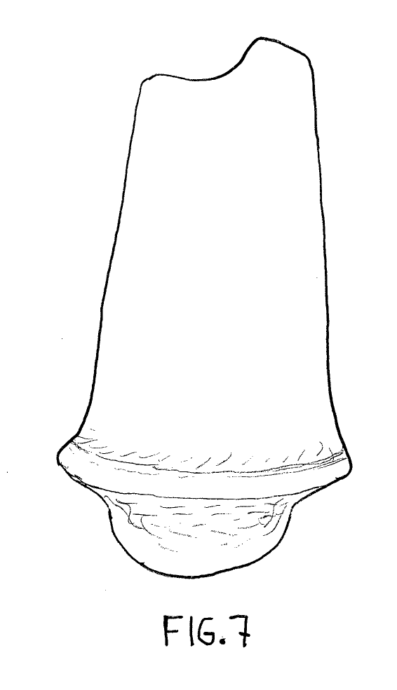

FIG. 4 is a top view of the photo unit,

FIG. 5 is a front view of the photo unit,

FIG. 6 is a schematic perspective view of the photo unit with a scanned dental object, and

FIG. 7 is a screenshot example of the scanned dental object.

In FIG. 1 it is illustrated a circuit diagram of an overall system for making dental restorations according to the invention, such as dental prostheses, bridges, crowns, caps, implants, abutments, inlays, onlays or the like. The arrangement generally comprises a number of scanning devices in the form of self contained computer-automated photo units 1 for scanning a model of a dental restoration, control device 2 for the scanning devices, online server 3 and manufacturing facilities 4. The computer-automated photo units 1 have been specifically developed and designed for use in a dental manufacturing system, but it should be understood that it can also be used for other custom objects. The specific design, size and functional details of each photo unit 1 will be described more in detail in connection with FIGS. 2-7 below.

According to the invention the scanning is performed by means of a self contained computer-automated photo unit 1 for taking a series of photographs for capturing the three-dimensional surface of the object in order to provide a passive 3D reconstruction of the object. Each unit has a private wife network 5 and is controlled by any kind of connected control device 2 such as mobile phone, tablet, personal computer, connected watches, internet browser or the like as schematically indicated in the drawing. Furthermore each unit 1 is connected to the online server 3 through internet. The online server is arranged to update, maintain and manage each unit 1 through a virtual private network, for instance a vpn network or any other known network protocol. The server then serves as a bridge between each photo unit 1 and the manufacturing facilities 4. The manufacturing facilities 4 receives all the 3D scans from the online server 3 and manufactures the custom object in question. According to the invention the photo studio unit is arranged to send all the information for manufacturing the dental restoration (Id, 3D file, parameters etc) to the online server when a manufacturing order is done. The online server 3 is then arranged to record all the data and transmit the data to the manufacturing machines 4. The arrangement might also include invoicing and means for order tracking and status information.

As illustrated in FIGS. 2 and 3 the photo unit 1 comprises a box-like housing 6 with an opening lid 7 for the interior of the unit. The photo unit comprises a white LED lighting system 8 for illuminating the object to scan so as to provide uniform illumination and substantially eliminate shadows. As illustrated in the figures the white LED lighting system 8 comprises a number a multiple number of individual LED light sources. The lighting system is computer-assisted from control device 2 for setting and modulation of the light. The photo unit also comprises means for controlling temperature etc, and wherein each of these means is integral within the housing. Instead of white LED lighting the system can also work with a different colour and/or background.

The photo unit 1 also comprises a computer-controlled built-in digital camera 9 with lens or objective. Lens is chosen to maximize the size of the object in the image and thereby maximize the 3D resolution. The object is positioned in front of the camera 9, centred on the optical axis 10 (see FIG. 4), on a turntable support 11 rotated by a stepper motor. A photograph is taken of the object every x degrees and the lightning system 8 is always on during scanning. x could be as small as 1.8 degrees and up to 40 degrees depending on the object to be scanned and the desired accuracy. For scanning of a dental object x is preferably less that 20 degrees. All the photographs are used for a passive 3D reconstruction, there is no structured light or laser used for the process. Preferably a magnetic connector or holder is used to maintain the object in place on the turntable support during scanning.

Appropriate software automatically synchronizes the motion of the turntable support 11 with the camera shooting so that a pre-selected number of photos is taken per rotation.

The size of the housing could be around 100 mm³ for a typical dental object scanning, but of course the scale can be adjusted depending on the size of the object to scan. The housing 6 is made of a solid printed casing material, such as aluminium or other durable and robust material. The housing is equipped with a computer card port (wifi, USB, Ethernet), and power supply (an external AC/DC 220 V/110 V input, 19 V output).

The individual parts of the photo unit 1, such as camera, lighting systems, stepper motor and turntable arrangement, computer connections etc is the choice of a person skilled in the art and will not be described in any further detail here.

FIG. 4 is a top view of the photo unit 1 indicating the location 12 for the object to scan. The object is positioned in front of the camera, centred on the optical axis 10. The white LED light 8 is indicated by arrows in the figure.

FIG. 5 is a front view of the photo unit 1 indicating the LED lighting system 8 and the camera position.

FIG. 6 is a schematic perspective view of the photo unit illustrating the position of a dental object 13 for scanning. The dental object 13 is positioned in front of the camera 9, centred on the optical axis 10 (see FIG. 4), on the rotatable turntable support. A photograph is taken of the object every x degrees and in FIG. 7 it is illustrated a screenshot example of the scanned dental object.

As an example of the present invention the following steps can be used for manufacturing a dental restoration or other custom object:

A model of the dental restoration is shaped in-vivo on a patient by the dentist. The model is then positioned in front of the camera 9, centred on the optical axis 10, in the photo unit 1 for photographs to be taken. The photographic process is commanded and controlled by the control device 2. Once the model has been scanned, a 3D graphic representation of the model is obtained. Any additional restorative design can then be made by the dentist on the display of the control device used. When an order is done, the photo unit sends the information for manufacturing to the online server 3. This information might include Id, the 3D file, parameters etc. The online server 3 records all the data and sends the data to a milling machine 4 for making the dental product. The manufacturing machine 4 receipts all the 3D scans from the online server 3 and manufactures the dental restoration or other custom object. It then sends the finished manufactured object to the customer/dentist.

The manufacturing facilities 4 might be a remote machining centre or an in-house machine in a dentists office. The machine itself might be a conventional CAD/CAM milling machine for dental use or a 3D printer or the like and which machines are not described here.

The invention is not limited to the above example but can be varied within the scope of the following claims.

1. Arrangement for manufacturing custom objects, for instance dental restorations such as dental prostheses, bridges, crowns, caps, inlays, onlays, implants, abutments or other dental products, said arrangement comprising a scanning device for scanning device for scanning a model of a dental restoration or other custom object, control means for the scanning device, online server and manufacturing facilities, and wherein the scanning device is in the form of a self contained computer-automated photo unit for taking, a series of photographs for capturing the three-dimensional surface of the custom object to provide a passive 3D reconstruction of the object, and wherein each unit has a private will network and is controlled by any kind of connected device such as mobile phone, tablet, personal computer, connected watches, internet browser or similar control means, and wherein each unit is connected to an online server for update, maintain, and manage each unit, and wherein each unit is arranged to send all the information for manufacturing the dental restoration or other custom object to the online server when a manufacturing order is done, characterised in that the photo unit for taking the photographs comprises a box-like housing with a turntable support for the object to be photographed, a computer-controlled built-in digital camera and a lighting system for illuminating the object to be photographed so that a photograph is taken of the object every x degrees, where x is less than 20 degrees.

2. An arrangement according to claim 1, characterised in that each unit is connected to the online server through internet, and said online server is arranged to update, maintain and manage each unit through a virtual private network, for instance a vpn network, record all the data and transmit the data to the manufacturing facilities.

3. An arrangement according to claim 2, characterised in that the arrangement includes means for invoicing for a manufacturing, order,

4. An arrangement according to claim 2, characterised in that the arrangement includes means for order tracking and status information.

5. An arrangement according to claim 1, characterised in that the lighting system for illuminating the object to be photographed provides a uniform illumination.

6. An arrangement according to claim 5, characterised in that the lighting system comprises a multiple number of individual LED light sources.

7. An arrangement according to claim 5, characterised in that the lighting system is computer-assisted from control device for setting and modulation of the light.

8. An arrangement accord to claim 1, characterised in that the turntable support is rotated by a stepper motor.

9. An arrangement according to claim 8, characterised in that the motion of the turntable support is automatically synchronized with the camera shooting by appropriate software so that a pre-selected number of photos is taken per rotation.

10. An arrangement according to claim 5, characterised in that all the individual parts of the photo unit, such as camera, lighting systems, stepper motor and turntable arrangement and means for controlling temperature etc, are integral within the box-like housing of the photo unit.

11. A method for manufacturing custom objects, for instance dental restorations such as dental prostheses, bridges, crowns, caps, inlays, onlays, implants, abutments or other dental products, comprising the following steps:
scanning a model of a dental restoration or other custom object, by means of a self contained computer-automated photo unit for taking a series of photographs for capturing the three-dimensional surface of the custom object to provide a passive 3D reconstruction of the object, and wherein the photo-unit comprises a box-like housing with a turntable support for the object to be photographed, a computer-controlled built-in digital camera and a lighting system for illuminating the object to be photographed and so that a photograph is taken of the object every x degrees, where x is less than 20 degrees,
controlling the self contained photo units by an kind of connected device such as mobile phone, tablet, personal computer, connected watches, internet browser or the like,
update, maintain and manage each unit by means of an online server, and
sending all the information for manufacturing the dental restoration or other custom object from the online server to the manufacturing facilities when a manufacturing order is done.
